(19) United States
(12) Patent Application Publication
(10) Pub. No.: US 2005/0127100 A1
(43) Pub. Date: Jun. 16, 2005

(54) Container for dispensing separate products

(76) Inventor: Fulvio Reggiani, Tradate (IT)

Correspondence Address: MODIANO & ASSOCIATI, Via Meravigli, 16, MILANO, 20123, IT

(21) Appl. No.: 10/932,069

(22) Filed: Sep. 2, 2004

(30) Foreign Application Priority Data
Dec. 12, 2003 (IT) MI2003U000588

(51) Int. Cl. B67D 5/52

(52) U.S. Cl. 222/135

(57) ABSTRACT

A container for dispensing separate products having a container body provided with a partition that forms at least two separate compartments; a closure body is connected to the container body, can hermetically engage each one of the compartments, and forms seats for accommodating dispensing valves that draw from the compartments.

### BACKGROUND OF THE INVENTION

As is known, in many fields of application and particularly in the field of cosmetics it is desirable to have two separate products to be dispensed simultaneously or, optionally, at successive times, depending on the criterion of application of the product.

To solve this problem, U.S. Pat. No. 5,356,040 already disclosed a container for dispensing cosmetic products that is substantially constituted by two separate container members that are joined one another by a coupling plate.

The containers can be used simultaneously or separately and have proved to be effective very valid from a functional standpoint, but suffer the drawback of being considerably expensive due to the need to assemble a plurality components.

### SUMMARY OF THE INVENTION

The aim of the invention is to solve the problem noted above, by providing a container for dispensing separate products that allows to perform both simultaneous dispensing and separate dispensing of the various products while having a single container element that can be manufactured easily.

Within this aim, an object of the invention is to provide a container that is quick and simple to assemble and that can meet all the requirements of the users.

A further object of the present invention is to provide a container that, thanks to its particular constructive characteristics, is capable of giving the greatest assurances of reliability and safety in use.

A further object of the present invention is to provide a container that can be easily manufactured starting from commonly commercially available elements and materials and that is also competitive from a merely economical standpoint.

This aim and these and other objects that will become better apparent hereinafter are achieved by a container for dispensing separate products, characterized in that it comprises a container body provided with a partition that forms at least two separate compartments, a closure body being connected to said container body, said closure body being able to hermetically engage each one of said compartments and forming seats for accommodating dispensing valves that draw from said compartments.

### BRIEF DESCRIPTION OF THE DRAWINGS

Further characteristics and advantages of the invention will become better apparent from the detailed description of the container for dispensing separate products, illustrated by way of nonlimiting example in the accompanying drawings, wherein:

FIG. 1 is a schematic sectional view of the container according to the invention;

FIG. 2 is an exploded sectional view of the container according to the invention;

FIG. 3 is a schematic perspective view of the closure body, shown exploded with respect to the container body;

FIG. 4 is a top plan view of the container, with a single actuation button;

FIG. 5 is a sectional view of a container with two separate actuation buttons;

FIG. 6 is a top plan view of the container with two separate actuation buttons;

FIG. 7 is a sectional view of the container with a flat gasket between the container body and the closure body.

### DESCRIPTION OF THE PREFERRED EMBODIMENTS

With reference to the figures, the container for dispensing separate products, according to the invention, generally designated by the reference numeral 1, comprises a container body 2, which can have any external shape deemed appropriate.

The container 2 is provided with a partition 3, which forms two separate compartments 4.

In the specific example, the container 2 has an oval shape and the partition affects the central position, thus providing two separate compartments; it is of course possible to provide a container that has another shape and the partition can be provided in various manners so as to obtain even more than two separate compartments.

An important feature of the invention consists in that a closure body is provided, generally designated by the reference numeral 10, which forms two inlets 11, which enter each compartment and are mechanically retained by way of protruding teeth 12, which mate in corresponding recesses 13 provided on the container.

At the free end of each inlet 11 an annular gasket 15, hermetically engages the internal walls of the container body 2 and of the partition 3, thus achieving a perfect seal with a single closure element that allows to separate each other the various compartments.

The closure body 10 is provided with a flange 20, which abuts against the upper rim of the container 2, and there is also an upper ridge 21, which allows coupling to a covering cap 22.

According to what is shown in FIG. 7, in order to provide a seal between the container body 2 and the closure body 10, a flat gasket 60 is accommodated in lower ridges 61 of the closure body 10. The ridges 61 abut over the upper rim of the container body 2 and of the partition 3.

The seats 30 for accommodating and hermetically coupling dispensing valves 31 are provided on the closure body. The valves draw from the individual compartments and are provided, in an upper region, with a dispensing duct 33 which, in a per se known manner, is inserted in the dispensing button.

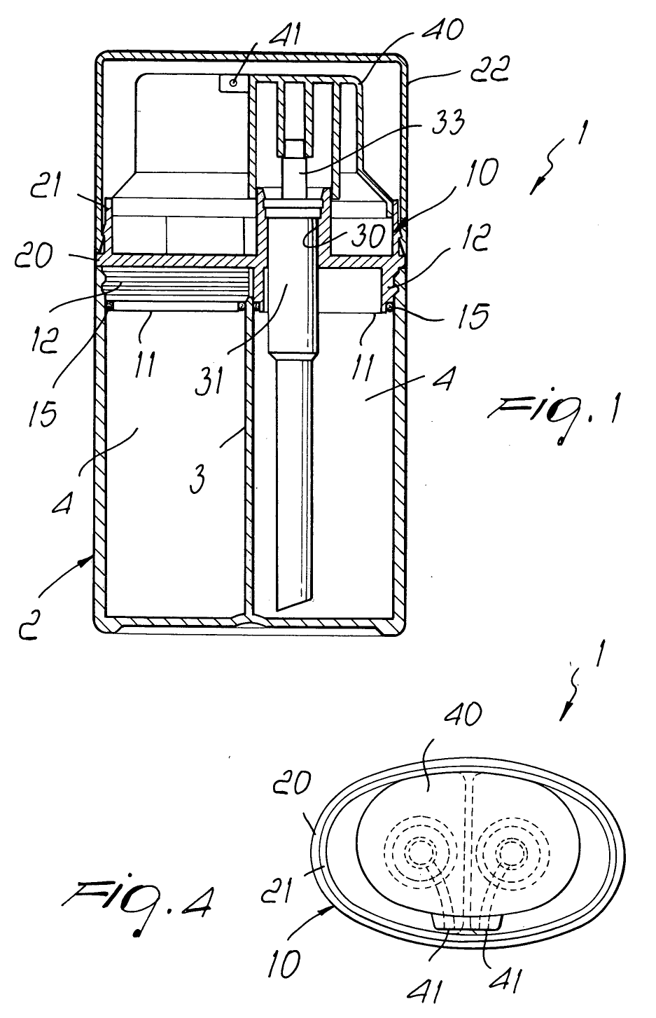

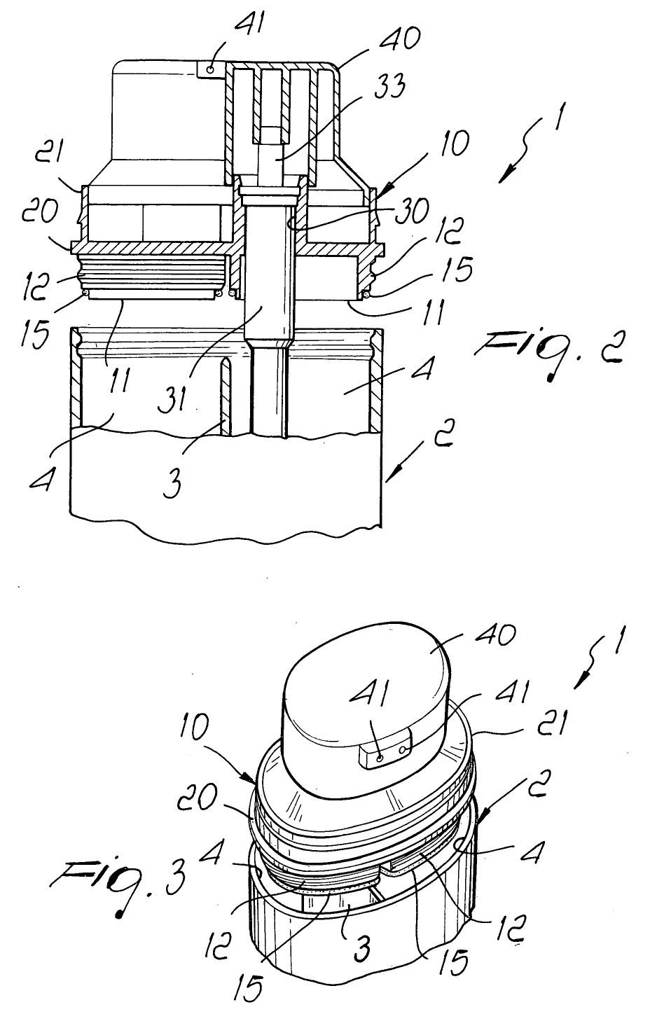

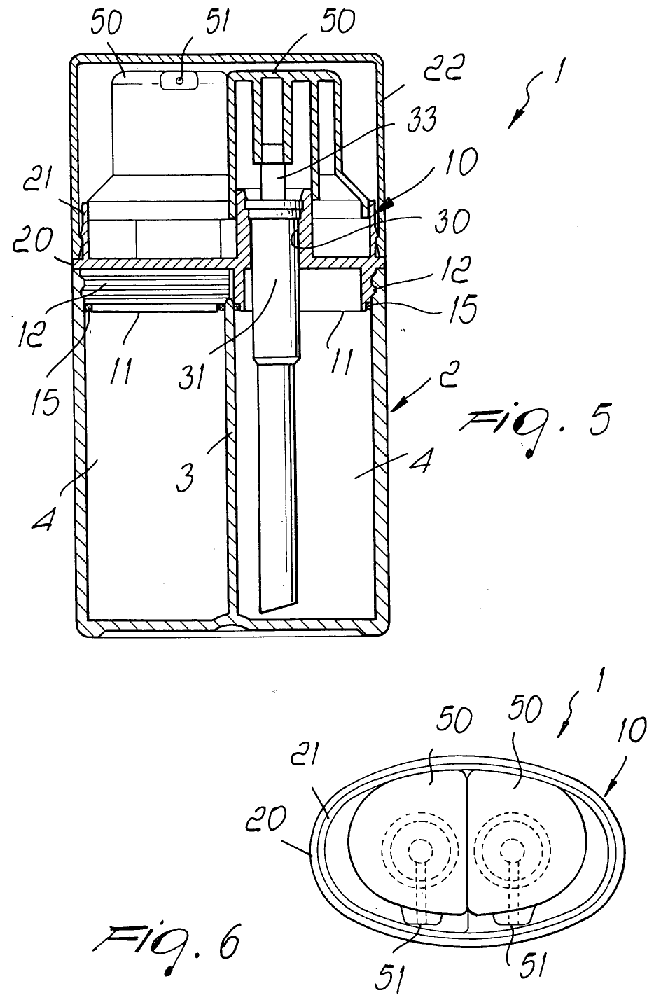

As visible in FIGS. 1 to 4, a dispensing button 40 allows to actuate simultaneously all the dispensing valves and is provided with separate dispensing nozzles 41 or optionally with a single dispensing nozzle into which the two dispensing ducts associated with the dispensing duct 33 merge.

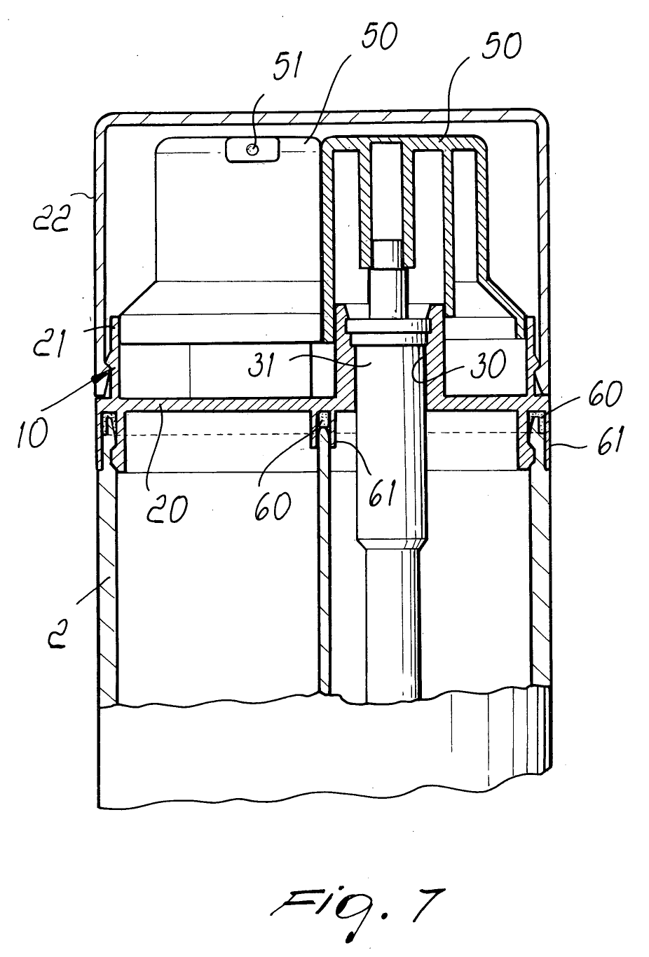

As visible in FIGS. 5 and 6, separate dispensing buttons 50 can be actuated independently of each other, and are each provided with a dispensing nozzle, designated by the reference numeral 51.

With the arrangement described above, the container allows to have a single button for the simultaneous dispensing of two or more products and to have a plurality of mutually separate buttons that allow to dispense the products separately according to the type of use.

From what has been described above, it is thus evident that the invention achieves the intended aim and objects, and in particular the fact is stressed that a container for dispensing separate products is provided which is structurally particularly simple and is obtained in practice by means of a single part on which a closure body is coupled which allows to hermetically separate the various compartments and to perform dispensing by using conventional dispensing valves.

In practice, the materials used, so long as they are compatible with the specific use, as well as the contingent shapes and dimensions, may be any according to requirements.

The disclosures in Italian Utility Model Application No. MI2003U000588 from which this application claims priority are incorporated herein by reference.

1. A container for dispensing separate products, comprising a container body provided with a partition that forms at least two separate compartments, a closure body being connected to said container body, said closure body being able to hermetically engage each one of said compartments and forming seats for accommodating dispensing valves that draw from said compartments.

2. The container according to claim 1, wherein said closure body forms at least one pair of inlets that can be inserted in the corresponding compartment.

3. The container according to claim 2, wherein said inlets are provided with protruding teeth for mechanical coupling in corresponding recesses formed in said container.

4. The container according to claim 3, comprising at least one annular gasket, which is associated with each one of said inlets and can hermetically engage the internal walls of said container body and of said partition.

5. The container according to claim 1, comprising a flat gasket that can be accommodated in lower ridges of said closure body, said lower ridges abutting against an upper rim of said container body and of said partition.

6. The container according to claim 1, wherein said closure body forms a flange that abuts against an upper rim of said container body.

7. The container according to claim 1, wherein said closure body has an upper ridge for detachable engagement with a closure cap.

8. The container according to claim 1, wherein each one of said dispensing valves has a dispensing duct that can be detachably coupled to a dispensing button.

9. The container according to claim 8, comprising a single dispensing button, which acts at said dispensing ducts.

10. The container according to claim 8, comprising a plurality of dispensing buttons, which are connected to the respective dispensing duct, said dispensing buttons being actuatable independently of one another.
